(19) United States
(12) Patent Application Publication
(10) Pub. No.: US 2016/0214778 A1
(43) Pub. Date: Jul. 28, 2016

(54) CLAMSHELL PACKAGING FOR SCENTED WAX THAT SERVES AS A TRAY WHEN WARMING THE WAX WITHIN A CANDLE WARMER

(71) Applicant: Rimports (USA) LLC, Provo, UT (US)

(72) Inventors: Jeff Goodsell, Springville, UT (US); Tyler Davis, Orem, UT (US); Todd Wilson, Orem, UT (US)

(21) Appl. No.: 14/603,165

(22) Filed: Jan. 22, 2015

(51) Int. Cl. B65D 75/36; H05B 3/00; B65D 65/38; B65D 85/00; B65D 25/04; B65D 47/32

(52) U.S. Cl. CPC B65D 75/367; B65D 25/04; B65D 47/32; B65D 65/38; B65D 85/70; H05B 3/00

(57) ABSTRACT

A clamshell packaging for scented wax can serve as a tray when warming the wax within a candle warmer. The clamshell packaging can be shaped and sized to fit within a dish of a candle warmer and can be made of a heat conducting material. In this way, the user can place the packaging directly in the dish of a candle warmer so that the wax is melted within the packaging rather than within the dish. After the wax has been used, the user can simply remove the packaging from the dish and throw it away. The clamshell packaging can include a lid with a number of vents to allow the wax within the base to be heated while the lid is secured over the base. These vents can be configured to control the rate at which the scent within the wax is emitted from the clamshell packaging.

### CROSS-REFERENCE TO RELATED APPLICATIONS

Not Applicable.

### BACKGROUND

Candle warmers are devices for heating scented wax. Candle warmers typically include a body in which a heat source is positioned and a dish in which the wax is heated that sits on or within the base. Different types of heat sources can be used including electrical heat sources (e.g., a light bulb) or a candle.

FIG. 1 provides an example of a prior art candle warmer 100. As shown, candle warmer 100 includes a body 101 and a dish 102 that sits within the body. Body 101 has a decorative appearance to allow candle warmer 100 to be used as a decorative element within the home or other location.

During use of candle warmer 100, wax can be placed in dish 102 where it is melted due to the presence of a heat source inside of body 101. Although the heated wax will initially emit a scent, at some point, no noticeable scent will be emitted even though wax remains in dish 102. As a result, the user may need to remove the used wax before again using the candle warmer. If the user attempts to clean out the old wax while it is still melted, it is possible that the user will spill the wax. In contrast, if the user waits for the wax to harden, it can be more difficult to remove the wax from the dish. In either case, it can be difficult to remove all remnants of the wax which may leave the dish with an undesirable appearance. Also, if remnants of the wax remain in the dish when new wax is added, the scents from the two waxes may mix producing an unpleasant odor.

### BRIEF SUMMARY

The present invention extends to clamshell packaging for scented wax that can serve as a tray when warming the wax within a candle warmer. The clamshell packaging can be shaped and sized to fit within a dish of a candle warmer and can be made of a heat conducting material. In this way, the user can place the packaging directly in the dish of a candle warmer so that the wax is melted within the packaging rather than within the dish. After the wax has been used, the user can simply remove the packaging from the dish and throw it away thereby alleviating many of the problems that exist with cleaning wax out of the dish.

The clamshell packaging can include a base in which the wax can be placed and a lid that is coupled to the base and configured to connect over the base. The lid can include a number of vents to allow the wax within the base to be heated while the lid is secured over the base. These vents can be configured to control the rate at which the scent within the wax is emitted from the clamshell packaging thereby prolonging the lifetime of the wax. The lid can also minimize the likelihood that wax will be spilled when the clamshell packaging is removed from the dish.

In one embodiment, the present invention is implemented as a clamshell packaging for scented wax that comprises a base having a concave shape for containing scented wax, the base being sized to fit within a dish of a candle warmer such that the scented wax can be melted within the base while the base is within the dish; and a lid coupled to the base, the lid having one or more vents to allow the scent to be emitted from the melted wax within the base while the lid is secured overtop the base.

In another embodiment, the present invention is implemented as clamshell packaging for scented wax that comprises a base having a concave shape for containing scented wax, an interior of the base forming a plurality of bowls for containing individual pieces of the scented wax, the base having a shape that corresponds with a shape of a dish of a candle warmer to allow the base to be placed in the dish; and a lid coupled to the base, the lid including one or more vents for venting the scent when the wax is melted while the lid is coupled overtop the base.

In another embodiment, the present invention is implemented as a candle warmer assembly that includes a candle warmer having a body and a dish. The body contains a heat source for distributing heat to the dish. The dish has a concave shape. The candle warmer assembly also includes a clamshell packaging for scented wax that comprises a base having a concave shape that corresponds with the concave shape of the dish so that the base can be placed within the dish to cause the scented wax to be melted within the base, and a lid that is configured to be secured overtop the base. The lid has one or more vents to allow the scent to escape from within the base when the lid is secured overtop the base and while the base is placed within the dish.

This summary is provided to introduce a selection of concepts in a simplified form that are further described below in the Detailed Description. This Summary is not intended to identify key features or essential features of the claimed subject matter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example of a prior art candle warmer in which the clamshell packaging of the present invention could be used;

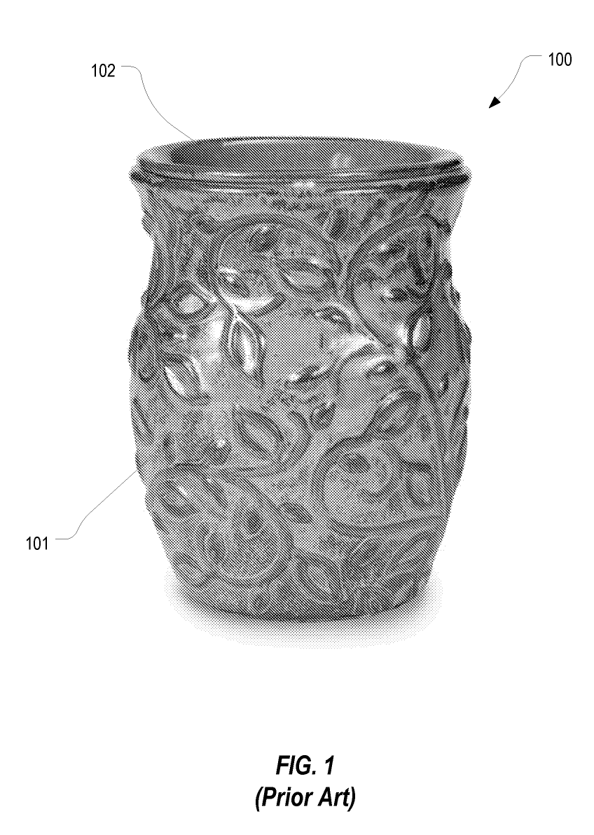

FIG. 2 illustrates a perspective view of an embodiment of the clamshell packaging of the present invention when the clamshell packaging is in an open configuration;

FIG. 3A illustrates a top view of the clamshell packaging of FIG. 2 when the clamshell packaging is in an open configuration;

FIG. 3B illustrates a side view of the clamshell packaging of FIG. 2 when the clamshell packaging is in a closed configuration;

FIG. 3C illustrates a side view of the clamshell packaging of FIG. 2 when the clamshell packaging is in an open configuration;

FIG. 4 illustrates an embodiment of the clamshell packaging of the present invention when the lid includes a number of vent openings;

FIG. 4A illustrates an embodiment of the clamshell packaging of the present invention when a coupling portion includes a perforation for separating the lid from the base; and

FIG. 5 illustrates a partial cross-sectional side view of a candle warmer in which the clamshell packaging of the present invention has been placed.

### DETAILED DESCRIPTION

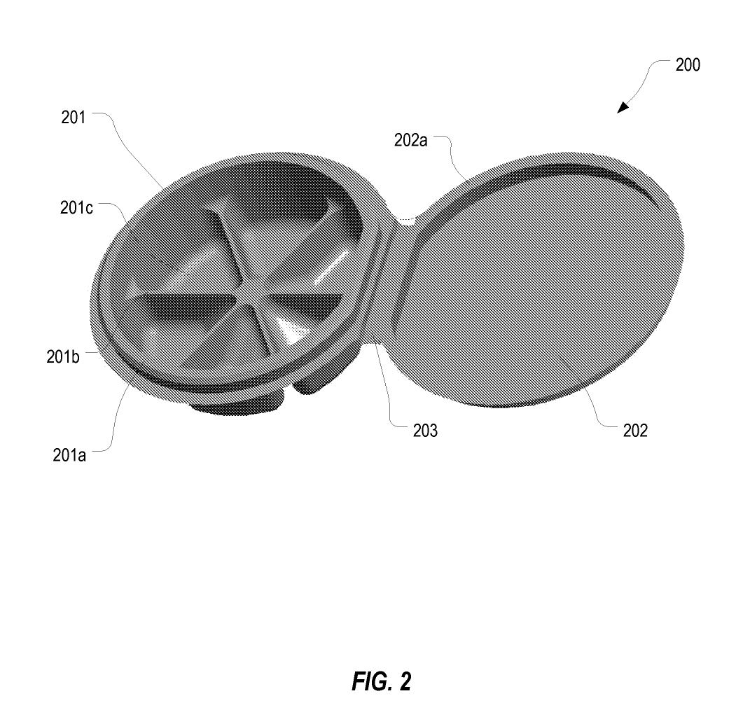

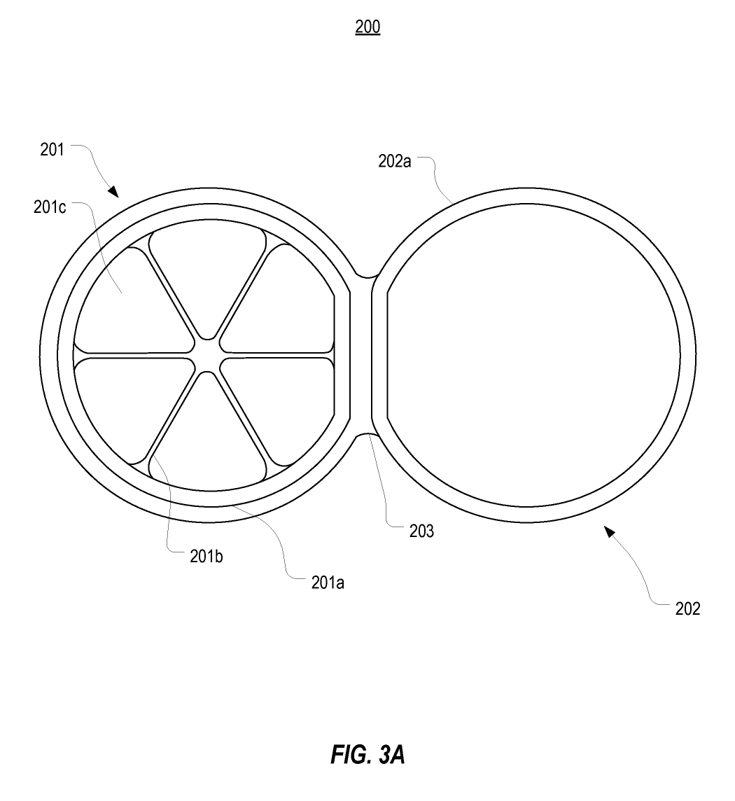

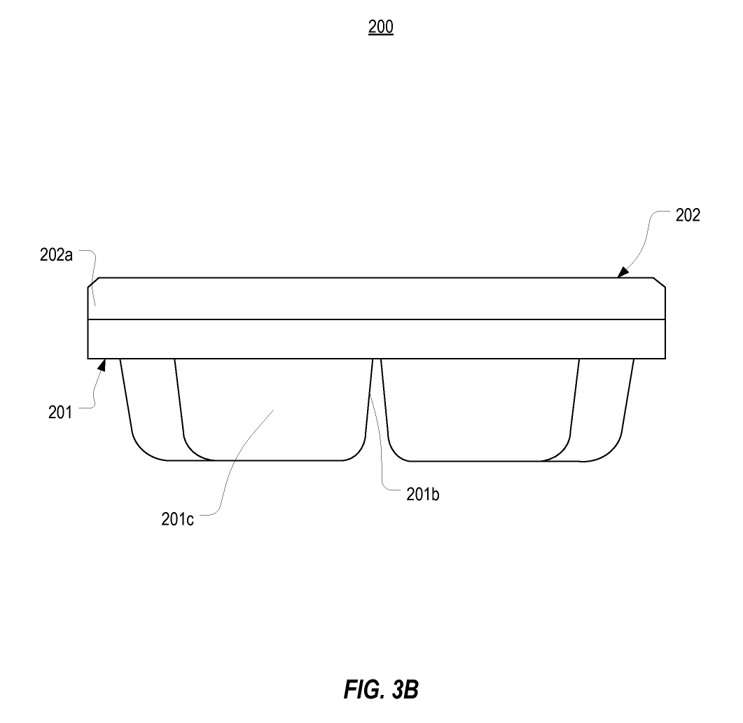

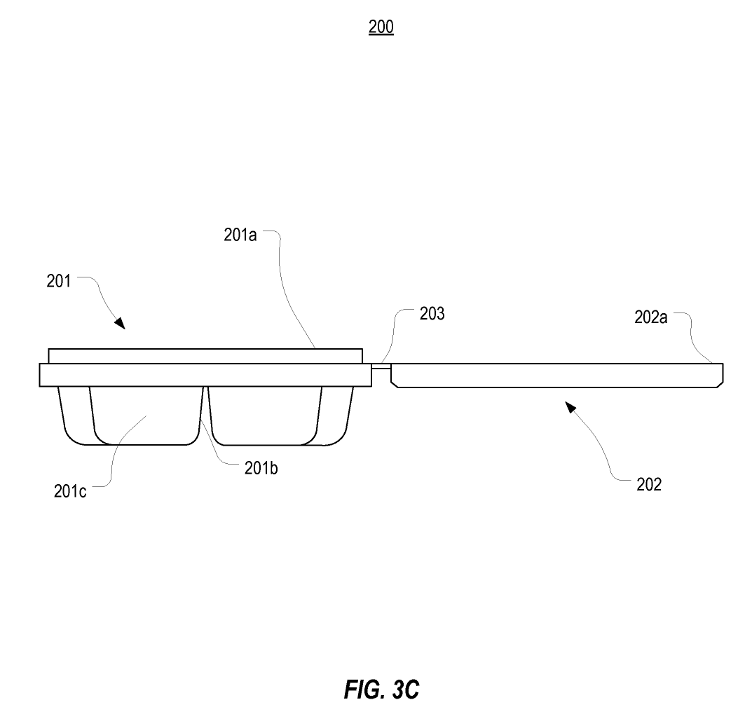

FIG. 2 illustrates a perspective view and FIG. 3A illustrates of top view of clamshell packaging 200 when the clamshell packaging is in an open configuration in accordance with one or more embodiments of the present invention. FIGS. 3B and 3C illustrate side views of clamshell packaging 200 when in a closed and open configuration respectively.

Clamshell packaging 200 includes a base 201, a lid 202, and a coupling portion 203 which couples the lid 202 to the base 201. Base 201 has a generally concave shape to allow the base to contain scented wax. Base 201 is shown as including a number of dividers 201b which form six separate bowls 201c.

Each of bowls 201c can be used to hold a separate piece of wax (not shown). By including a number of bowls 201c, clamshell packaging 200 can be used to provide a number of pieces of wax so that the pieces can still be used individually if so desired. In other words, if a user desired to melt a single piece of wax within clamshell packaging 200, the other pieces of wax could be removed from the packaging prior to inserting the packaging into the dish of a candle warmer. Similarly, if the user desired to melt a single piece of wax directly within the dish of the candle warmer, the user can remove a single piece of wax from the packaging. Although base 201 is shown as including six bowls 201c, in other embodiments, dividers 201b can be configured to provide a greater or lesser number of bowls. Similarly, dividers 201b could be configured to form bowls having a different shape from what is shown in FIG. 2.

Base 201 also includes a raised surface 201a that extends around the base. Lid 202 includes a corresponding raised surface 202a that also extends around the lid. Raised surface 202a has inner dimensions that match outer dimensions of raised surface 201a such that when lid 202 is placed overtop of base 201, raised surface 202a is secured around raised surface 201a. Alternatively, raised surfaces 201a, 202a could be configured so that raised surface 201a extends around raised surface 202a when lid 202 is placed overtop base 201.

Although clamshell packaging 200 has a circular shape, a clamshell packaging in accordance with embodiments of the present invention could have another shape such as a square shape, a rectangular shape, or a triangular shape. The shape of clamshell packaging 200 can be configured to match the shape of a dish of a candle warmer so that the clamshell packaging can be placed into the dish. Clamshell packaging 200 can be made of a heat conducting material having a melting point higher than the melting point of wax including plastic materials such as, for example, polypropylene. In this way, heat that is produced by a heat source within a candle warmer can be transferred to the clamshell packaging to ensure adequate melting of the wax.

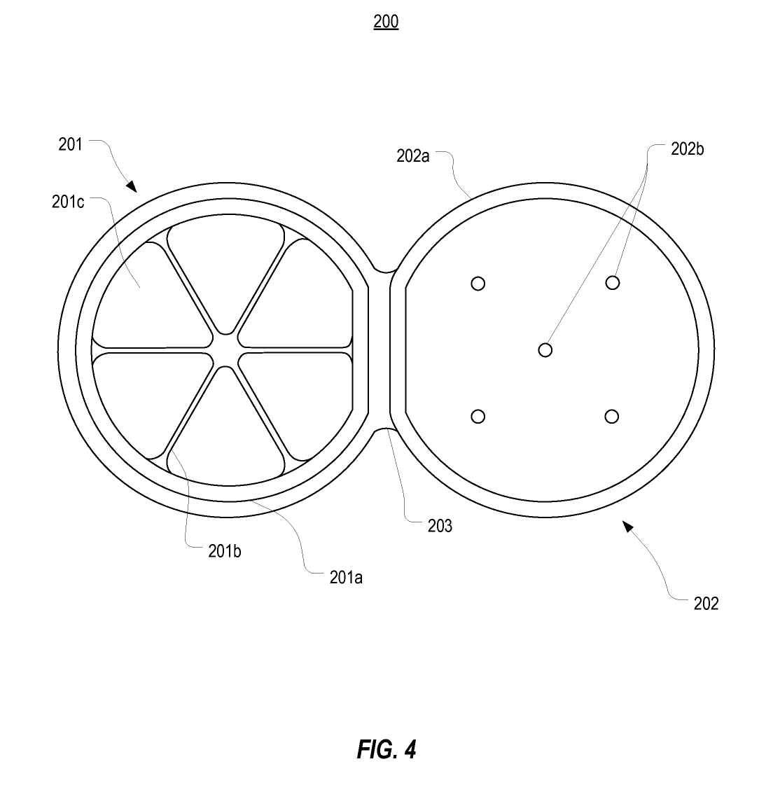

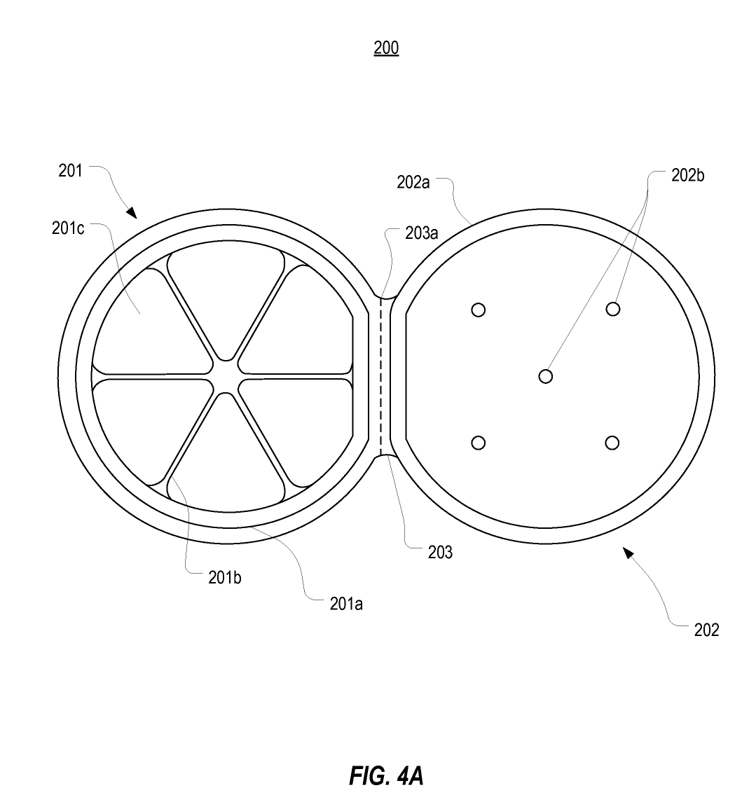

FIG. 4 illustrates an embodiment of clamshell packaging 200 where lid 202 includes a number of vents 202b. Vents 202b allow lid 202 to be secured overtop of base 201 while wax is melted within base 201. In particular, vents 202b can facilitate the emission of scents from clamshell packaging 200 at a controlled rate. In some embodiments, vents 202b can initially be sealed. Then, when the user is ready to melt the wax within clamshell packaging 200, the user can open one or more of vents 202b so that scent will be released at a user selectable rate. For example, if the user would like to have a stronger scent for a shorter amount of time, the user may open all of vents 202b. In contrast, if the user would like to have a weaker scent that lasts longer, the user may open less than all of vents 202b. To facilitate opening of vents 202b, a number of perforations can be made in lid 202 in the desired shapes so that the user can easily pop open the vents. Alternatively, a sticker may be placed overtop of vents 202b during packaging which the user can remove as desired to open one or more of the vents.

In some embodiments, coupling portion 203 can be detachable from base 201 so that base 201 can be used with or without lid 202. For example, coupling portion 203 can include interlocking structures to allow lid 202 to be selectively detached from and attached to base 201. Alternatively, coupling portion 203 can include perforations 203a as shown in FIG. 4A to facilitate cutting or tearing away lid 202 from base 201. In either case, raised surfaces 201a, 202a can be used to couple lid 202 to base 201 even if coupling portion 203 has been severed. Accordingly, lid 202 can be completely removed during heating of the wax and later reattached to reseal any unused wax within clamshell packaging 200.

As best shown in FIG. 2, a top surface of dividers 201b can be spaced a distance from a top surface of raised surface 201a. In this way, an air space will exist between lid 202 and the top surface of the wax (which may be at or near the top surface of dividers 201b) while the wax is being heated. This air space can allow the scent released from the wax to flow out from clamshell packaging 200 through vents 202b at the desired rate.

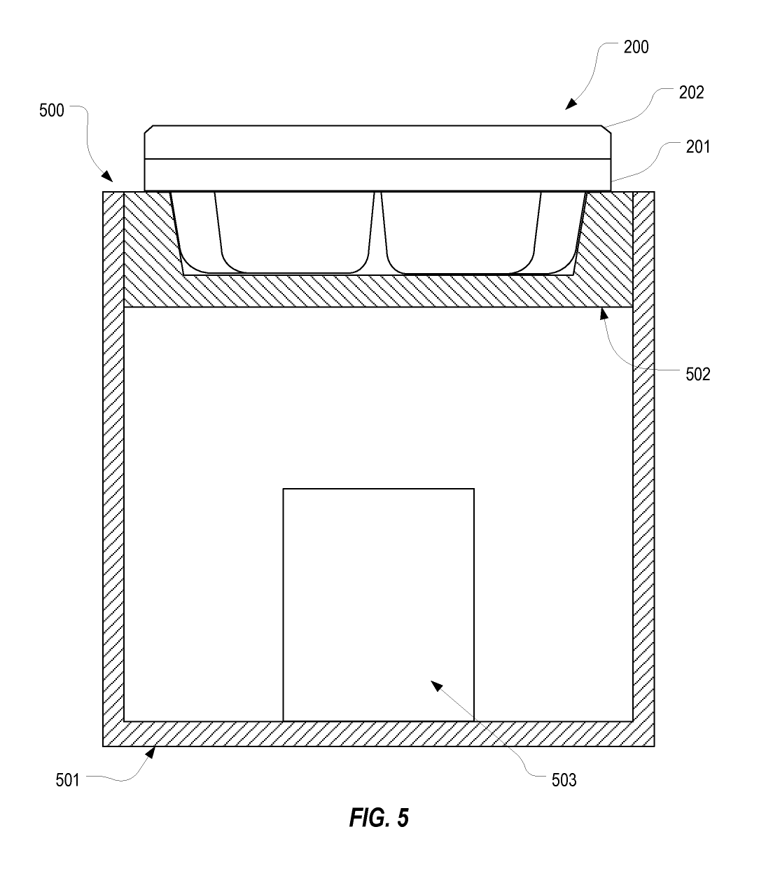

FIG. 5 illustrates a partial cross-sectional side view of a candle warmer 500 in which clamshell packaging 200 has been placed. In FIG. 5, body 501 and dish 502 of candle warmer 500 are cut away to illustrate how clamshell packaging 200 sits within dish 502. As shown, base 201 sits within dish 502 to allow base 201 to be heated by heat source 503. Lid 202 is coupled overtop base 201 while the wax within base 201 is heated. The outer dimensions of base 201 are sufficiently large so that a portion of base 201 rests on or over a top surface of dish 502. In this way, clamshell packaging 200 can easily be removed from dish 502 even when dish 502 is heated. After the wax within clamshell packaging 200 has been used, clamshell packaging 200 can be removed from dish 502 and thrown away. Therefore, the user does not have to clean any wax from dish 502.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description.

What is claimed:

1. A clamshell packaging for scented wax comprising:
a base having a concave shape for containing scented wax, the base being sized to fit within a dish of a candle warmer such that the scented wax can be melted within the base while the base is within the dish; and
a lid coupled to the base, the lid having one or more vents to allow the scent to be emitted from the melted wax within the base while the lid is secured overtop the base.

2. The clamshell packaging of claim 1, wherein the base includes one or more dividers which form bowls within the base, each bowl forming a separate piece of scented wax.

3. The clamshell packaging of claim 1, wherein the base and the lid each include a raised surface for securing the lid overtop the base.

4. The clamshell packaging of claim 3, wherein an outer dimension of the raised surface of the base corresponds with an inner dimension of the raised surface of the lid such that the raised surface of lid surrounds the raised surface of the base when the lid is secured overtop the base.

5. The clamshell packaging of claim 1, wherein the one or more vents are initially closed and can be selectively opened by a user to control a rate at which scent is emitted from the clamshell packaging.

6. The clamshell packaging of claim 1, wherein the one or more vents comprise a plurality of vents.

7. The clamshell packaging of claim 1, wherein the clamshell packaging comprises a plastic having a melting point higher than a melting point of wax.

8. The clamshell packaging of claim 1, wherein the base includes a raised surface that couples to a raised surface of the lid to secure the lid over the base, the base also including one of more dividers which form bowls within the base, a top surface of the dividers being spaced a distance from the raised surface of the base such that an air space is formed between the lid and the dividers.

9. The clamshell packaging of claim 1, wherein the lid is detachable from and attachable to the base.

10. A clamshell packaging for scented wax comprising:
a base having a concave shape for containing scented wax, an interior of the base forming a plurality of bowls for containing individual pieces of the scented wax, the base having a shape that corresponds with a shape of a dish of a candle warmer to allow the base to be placed in the dish; and
a lid coupled to the base, the lid including one or more vents for venting the scent when the wax is melted while the lid is coupled overtop the base.

11. The clamshell packaging of claim 10, wherein the base has a circular shape.

12. The clamshell packaging of claim 10, wherein the base includes a raised surface that extends around the base, and the lid includes a raised surface that extends around the lid, the raised surface of the base interlocking with the raised surface of the lid to secure the lid overtop the base.

13. The clamshell packaging of claim 12, wherein the raised surface of the lid has inner dimensions that are substantially equal to outer dimensions of the raised surface of the base such that the raised surface of the lid surrounds the raised surface of the base when the lid is secured overtop the base.

14. The clamshell packaging of claim 13, wherein the base includes a plurality of dividers which form the bowls.

15. The clamshell packaging of claim 14, wherein a top surface of the dividers is spaced a distance below the raised surface of the base.

16. The clamshell packaging of claim 10, wherein the vents are initially closed and are configured to be selectively opened by a user.

17. A candle warmer assembly comprising:
a candle warmer having a body and a dish, the body containing a heat source for distributing heat to the dish, the dish having a concave shape; and
a clamshell packaging for scented wax, the clamshell packaging comprising:
a base having a concave shape that corresponds with the concave shape of the dish so that the base can be placed within the dish to cause the scented wax to be melted within the base; and
a lid that is configured to be secured overtop the base, the lid having one or more vents to allow the scent to escape from within the base when the lid is secured overtop the base and while the base is placed within the dish.

18. The candle warmer assembly of claim 17, wherein the base includes a raised surface that extends around the base, and the lid includes a raised surface that extends around the lid, the raised surface of the base coupling to the raised surface of the lid to secure the lid overtop the base.

19. The candle warmer assembly of claim 18, wherein the raised surface of the lid extends around the raised surface of the base when the lid is secured overtop the base.

20. The candle warmer assembly of claim 17, wherein the one or more vents are initially closed and are selectively opened by a user.
